(19) United States
(12) Patent Application Publication
(10) Pub. No.: US 2009/0156134 A1
(43) Pub. Date: Jun. 18, 2009

(54) System for Conducting Secure Digital Signing of and Verification of Electronic Documents

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/144,290

(22) Filed: Jun. 23, 2008

Related U.S. Application Data
(60) Provisional application No. 61/013,913, filed on Dec. 14, 2007.

(51) Int. Cl. H04B 1/38

(52) U.S. Cl. 455/73

(57) ABSTRACT

A computerized appliance, typically configured as a pocket-portable device, has a central processing unit (CPU), a non-volatile data repository, a wireless transceiver, and a first code set resident and executable by the CPU in response to commands and data received at the appliance via the wireless transceiver. A first function of the first code set is to configure the appliance to execute, in response to an input signal via the wireless transceiver, a second code set resident and executable by the CPU, the second code set managing communication with one or more external wireless devices via the wireless transceiver.

### CROSS-REFERENCE TO RELATED APPLICATIONS

The present invention claims priority to a U.S. provisional patent application Ser. No. 61/013,913, filed on Dec. 14, 2007, entitled “Hermetically-Sealed Thumb Drive Flash Memory Device”, disclosure of which is incorporated at least by reference.

### BACKGROUND OF THE INVENTION

1. Field of the Invention

The present invention is in the field of data storage devices and drives and pertains particularly to a hermetically sealed storage drive accessible through a wireless interface from a computerized appliance.

2. Discussion of the State of the Art

In the field of data storage devices, the Flash drive, also called a thumb drive or jump drive in the art is one of the most prevalent peripheral storage devices used to store data in a fashion that is transportable between computing appliances. A Thumb drive is a universal serial bus (USB) device that is immediately recognizable as a removable data drive when it is plugged into a USB port on a computer host.

As memory fabrication technologies have improved over recent years, thumb drives have been provided with multiple gigabytes of Flash memory. Ultra-high-speed USB interfaces also enable very fast data transfers to and from the device. A single thumb drive may be robust enough to provide an entire data backup for one or more computing devices. In many applications, thumb drives are relied upon for storing graphics, music files, and video files. Some users prefer to store important documents and work files. Others use the drive as a backup location to backup important files from a host system to the removable drive.

There are some inconveniences, however, regarding current thumb drives. One is that they are limited in connection type to a USB connection that must be supported by a host computer. A thumb drive must derive power in most cases through the USB port from a host computer. Further, internal components of a thumb drive are vulnerable to the elements. Prolonged exposure to moisture, magnetic force, extreme heat, or dusty conditions may affect performance of the drive over time or cause it not to perform at all. A traditional thumb drive is physically docked to a host. Therefore, the only access to the drive is through the host. A host/client USB interface connects one host to one device.

More recently such drives have been provided that also contain wireless networking components so that the functions of a network card and flash drive are integrated into one USB device. A limitation of such a device is that it still must be docked or ported to a host computer.

What is clearly needed is a standalone wireless non-volatile memory device that solves the problems stated above relative to thumb drive limitations. Such a device would enable a more flexible computing environment relative to removable storage access and data management.

### SUMMARY OF THE INVENTION

A problem stated above is that standard Flash drives, also referred to as thumb drives, are limited relative to device connection with a host appliance and contain components that are vulnerable to external elements. A USB device requires USB support from a host and is typically limited to being a client device of the host it is connected to.

The inventor therefore considered functional elements of USB devices and wireless computing systems looking for components that might be leveraged to add flexibility and expanded utility to a Flash-based device. Every USB storage device requires power to enable access and use of the device. Likewise, USB protocols are designed specifically for device to device interaction where one of the devices is a host device.

Every Flash-based USB device depends on USB protocols in order function as an accessible data storage drive to a connected host computer. One byproduct of the single channel modality is limited access to a single connected host at a time.

The inventor realized in an inventive moment that if, at the point of manufacture, standalone wireless capability and data processing capability could be provided in a small space utilizing micro components and logic support for multiple modes could be included through programmable circuitry, software and/or firmware, a more flexible and useful appliance would result. The inventor therefore conceived and subsequently developed a unique multimodal miniature appliance that enables users to use the appliance as a network node and as a wirelessly enabled controller for a wide variety of tasks. A significant advancement in device flexibility and utility results with no increased maintenance or monitoring of the device required by users.

Accordingly, in one embodiment of the invention a computerized appliance is provided comprising a central processing unit (CPU), a non-volatile data repository, a wireless transceiver, and a first code set resident and executable by the CPU in response to commands and data received at the appliance via the wireless transceiver. A first function of the first code set is to configure the appliance to execute, in response to an input signal via the wireless transceiver, a second code set resident and executable by the CPU, the second code set managing communication with one or more external wireless devices via the wireless transceiver.

In one embodiment a second function of the first code set is to receive and store a plurality of second code sets for later execution. Also in an embodiment a third function of the first code set is to recognize specific wireless signals and to establish network communication with other computerized appliances in response. The appliance may be preferably configured as a pocket-portable device.

In some embodiments the appliance is hermetically sealed, and further comprises a power supply coupled to an inductive charger mechanism. There may also be one or more input button switches for providing signals to the appliance, and the button switches may be membrane switches, providing input through the seal without breaking the seal.

In some embodiments the appliance connects wirelessly to one or more computerized host appliances and is recognized by the one or more host appliances as a removable drive, and may function as a shared resource on a network or as a remote controller to a third-party utility. Also in some embodiments the wireless transceiver operates with one or more protocols, including Bluetooth™, Wireless Wi-Fi, or Ultra Wide Band (UWB). There may be in some embodiments a graphic display, and in some embodiments a USB connector for engaging a mating connector of another computerized appliance.

### BRIEF DESCRIPTION OF THE DRAWING FIGURES

FIG. 1 is an architectural view of a wireless connection between a computerized appliance and a data storage device according to an embodiment of the present invention.

FIG. 2 is an architectural view of a wireless network of computer appliances and the data storage device of FIG. 1.

FIG. 3 is an architectural view of the data storage device of FIG. 1 connected wirelessly to one or more devices according to an embodiment of the present invention.

FIG. 4 is a block diagram illustrating basic electronic components of the data storage device of FIG. 1.

FIG. 5 is a top view of a removable dual-mode adapter head for the data storage device of FIG. 1 according to an embodiment of the present invention.

FIG. 6 is a top view of the adapter head of FIG. 5 with the USB connector shown retracted.

### DETAILED DESCRIPTION

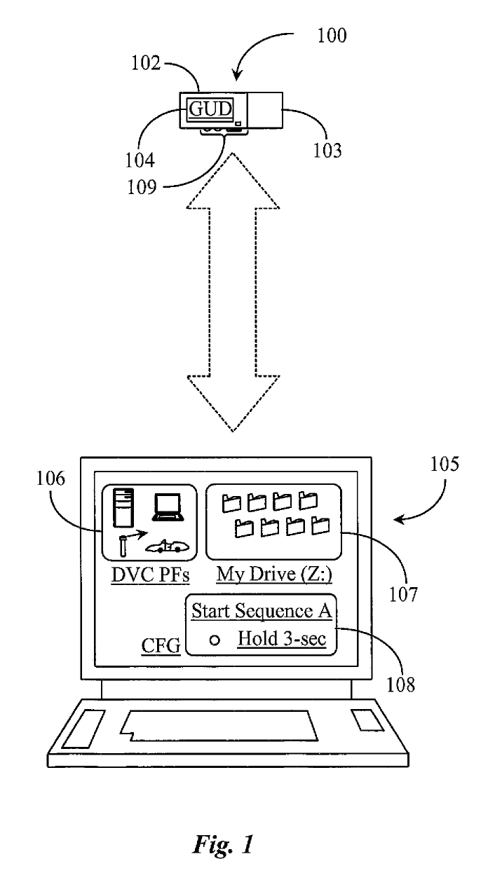

FIG. 1 is an architectural view of a wireless connection between a computerized appliance 105 and a data storage device 100 according to an embodiment of the present invention. Data storage device 100 is adapted in one embodiment to function as a universal serial bus (USB) data drive. Data storage device 100 may be referred to as device 100 throughout this specification. Device 100 may be manufactured in two parts that may be snapped together to complete the unit. A hermetically sealed cavity 102 is provided as one of the two parts mentioned above. Cavity 102 is adapted to enclose and to isolate electronic components of device 100, including device memories from the outside environment through use of hermetic sealing.

The other of the two components provided in the manufacture of device 100 is a wireless adapter head 103. Wireless adapter head 103 in one embodiment contains a wireless communications transceiver connected through a hermetic seal to the electronic circuitry in cavity 102. One method for establishing such a connection is by providing a contact wire through the hermetic seal. A connection between the transceiver and the rest of the device circuitry may be established by snapping adapter head 103 onto enclosure or cavity 102.

In an alternative embodiment all of the circuitry including the wireless transceiver is disposed within hermetic cavity 102. The hermetic seal of device 100 protects the circuitry and memories from exposure to elements that might eventually corrode or damage the circuitry. In one embodiment adapter head 103 may include a wireless transceiver and a retractable physical USB connector. In another embodiment two modular adapter heads may be provided for the device. One adapter head may contain wireless transceiver circuitry for enabling wireless communication between device 100 and a computerized appliance enabled for wireless communication. Another adapter head may contain a physical USB connector but not wireless transceiver circuitry enabling traditional porting of device 100 to a computerized appliance as a typical thumb drive.

In this example device 100 includes a graphic user display (GUD) 104. Display 104 may be a light emitting diode (LED) display, a liquid crystal display (LCD), an organic light emitting diode (OLED) or a polymer light emitting diode (PLED) display. Display 104 may include status lights or indicators as may be needed to inform a device user of device status. In one embodiment one or more status indication lights may be provided on the peripheral surface of hermetic cavity 102 and electrically connected through the hermetic seal to internal contact points. It is noted that one or more electrical leads may be routed through a hermetic seal without corrupting the main benefit of sealing.

Device 100 may be powered by battery or power cell and may be charged through inductive charging methods known in the art. In a future embodiment electricity to charge the device may be delivered wirelessly to the device using wireless electricity transmission methods currently being developed. More detail about device function and power management will be provided further below.

Device 100 may include a user interface control panel or array of control buttons collectively illustrated herein as control buttons 109. Control buttons 109 may include a wireless burst, or send, control button for specific applications. Device 100 is a bootable device in some embodiments. Powering on device 100 may be accomplished through a hermetic seal using a reed switch or a membrane switch. Device 100 functions as a USB thumb drive in this example without requiring a USB connector component. The device may be recognized by a computer appliance as a removable drive once a wireless connection is established between the device and the appliance.

As described above, display 104 of device 100 is typically a limited display; however in some embodiments device 100 may be configured to co-opt and use a display of another appliance when in proximity. For example, most persons carry a cellular telephone, and in certain circumstances device 100 may communicate wirelessly with the telephone and display information and graphics on the display of the cell phone instead of its own display 104.

Computerized appliance 105 is a Laptop computer in this example. Other types of computer appliances may also be used to connect to device 100 wirelessly including but not limiting to a cellular telephone, a personal digital assistant, a personal computer, a music player, and other devices that are enabled generically or through external adaptation for wireless communication.

Laptop 105 has a wireless link established between itself and device 100. The wireless link (illustrated by broken arrow) may be a Bluetooth™ connection, a Wi-Fi connection, an ultra wide band (UWB) connection such as wireless universal serial bus (WUSB) or some other wireless transmission method that can be adapted to support wireless USB protocols.

Laptop 105 recognizes device 100 as a peripheral drive as is illustrated by a display 107 open to drive Z and illustrating file folders stored on the device. Another display 106 is open to show device profiles (DVC PFs). Device 100 may be pre-programmed to interface with a variety of systems and utilities through wireless adaptation of those systems and utilities to enable a one-way or bi-directional communication link between the device and the controller features of those systems or utilities. Wireless adaptation to device 100 can be accomplished by coupling a wireless receiver or transceiver to switch controls, feature select controls, and other interfacing circuitry generic to such systems and utilities.

Display 106 illustrates that device 100 is configured to more than one system or utility represented in the display by selectable icons. Software (SW) may be provided to run the display and to enable pre-configuration, set-up and setting of wireless adaptation parameters required for integrating the device to a system or utility.

A Laptop icon (top right) in display 106 may indicate a configuration of device 100 as a wireless USB device useable with one computerized appliance or on a network of computerized appliances. A server icon (top left) in display 106 may indicate a configuration of device 100 as a network server administration device used, for example, to update server software and to perform maintenance or other dedicated tasks. An automobile icon (bottom right) in display 106 may indicate that device 106 is configured to lock and unlock the doors of the auto and perhaps to perform other tasks as well related to the automobile. Presetting a music channel on an XM radio; setting AC controls; starting or stopping the automobile motor; starting a DVD; running an engine diagnostic test; are just some tasks that device 100 can be configured to do with proper adaptation for the automobile systems that would be accessed. A directional sprinkler head icon (bottom left) may indicate that device 100 is pre-configured to start and stop a valve-controlled sprinkler or watering system.

Another option (icon not shown) may be a device 100 configured to communicate, when in fairly close proximity, with an appliance like a refrigerator. Functionality may be developed, for example, such that passing the refrigerator might update a file in the device as to items typically stored in the refrigerator that need to be replaced.

A third display 108 illustrates a device control configuration (CFG) pane or panel that is supported by device software and that can be “called to screen” for reassigning one or more control buttons (109) of device 100 relative to adapting the device for controlling another system or utility. In this example a user is configuring a button on device 100 to start a specific sequence A of a watering system that may involve several watering heads categorized under sequence A for sequential timed watering. In this case the user assigns a parameter “Hold 3-seconds” to the button. After configuration, the user may operate the device directly to start sequence A of the watering system by pointing the device at the system controller and depressing and holding the button in question for 3 seconds. The device has to be booted and the wireless connection established between the device and the controller for the sprinkler system before the user can turn the sprinkler head on via the device. A wireless receiver or transceiver at the controller receives the command and converts the command to the generic task command normally manually available through a generic interface.

Electrical adaptation of a system or utility that formerly was not designed for wireless control may include installation of an aftermarket software or firmware, the wireless adapter hardware (including wireless transceiver), and some wiring to specific switches or other components. Custom device-client boxes may be provided for specific system or utility types or models to facilitate user-friendly adaptation to device 100.

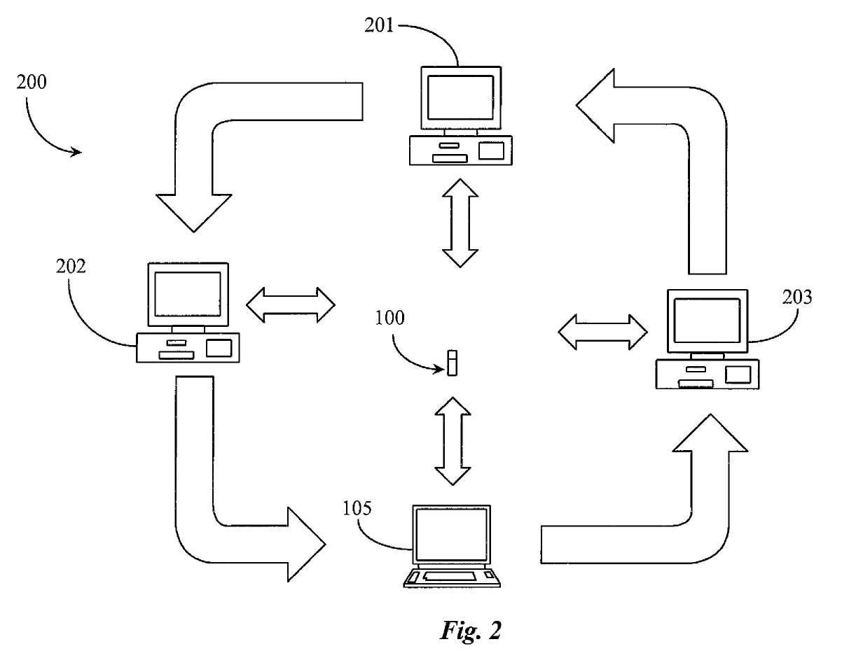

FIG. 2 is an architectural view of a wireless network of computer appliances and data storage device 100 of FIG. 1. Data storage device 100 may be recognized and used as a flash or thumb drive by Laptop 105 as described further above. Laptop 105 may also be connected to an ad-hoc wireless network. A wireless network 200 includes a computerized appliance 201, a computerized appliance 202, and a computerized appliance 203. In this embodiment the computerized appliances are PCs. Other computerized appliances may engage in wireless networking such as Laptop 105 and other computing nodes capable of wireless communication. Such appliances may engage one another for the purpose of collaborating and file sharing as is generally known in the art of wireless networking.

Device 100 may be adapted as a USB data storage device for all of the computerized appliances on network 200. Device 100 is configured to function as one of the nodes on the network and may have a network address assigned to it for access purposes. Powering on device 100 in the local vicinity of the networked computers causes the device to appear in the network configurations of all of the nodes on network 200. Device 100 may serve as a shared data storage device. A user operating computerized appliance 105 may use one or more programs installed on device 100 to perform tasks relative to the other network nodes such as file syncing or updating, virus checking, software distribution, and so on. Shared folders may be configured on device 100 for sharing information with some or all of the nodes in network 200.

In one embodiment a user may configure a mode button on device 100 for pushing a certain file, file set, .exe file, .Web file, music file, or streaming media to one or more of the computerized appliances on network 200. Device 100 may serve both as a shared data storage device for the network session as well as a central server or synchronization point for the nodes on the network. Multiple channel support may be built into the wireless capability of device 100 so that the other network nodes may asynchronously access and interact with the device for file service or data storage. In one embodiment the device may be pre-configured to automatically log on to a wireless network as a standalone network node when it is powered on. Power to the device may be supplied by rechargeable power cell, battery, or through a separate docking station or magnetic induction charging device.

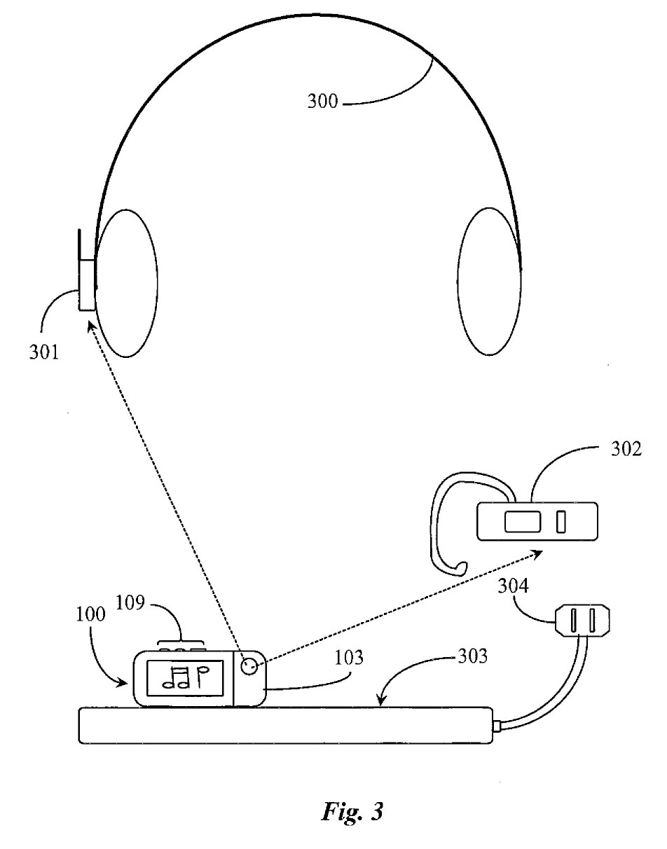

FIG. 3 is an architectural view of data storage device 100 of FIG. 1 connected wirelessly to one or more devices according to an embodiment of the present invention. Data storage device 100 may be powered by battery or power cell and may be recharged using magnetic induction via an induction charger illustrated herein as charger 303. Device 100 may be docked into the charging pad or it may simply rest on the surface of the charging pad. Charging pad 303 may be plugged into a power outlet using plug 304, and optionally may have a battery that recharges, and then the charger may be more portable.

Device 100 may be configured to stream music stored thereon to a variety of appliances adapted to receive digital audio and to convert the audio to analog music played over a speaker system of one or more speakers. An audio headset 300 is illustrated in this example. Audio headset 300 has a device-client module 301 coupled thereto and adapted to receive streaming music from device 100 using Bluetooth™ or another compatible wireless protocol. A hands-free ear piece 302 is illustrated herein as another device that may receive an audio stream from device 100 using Bluetooth™ or another wireless protocol.

Mode control buttons 109 may be preconfigured to play and stream music to either device. Device 100 may be configured to stream music to other systems adapted for wireless reception of digital streaming music such as a wireless speaker system, an entertainment center, or other such systems. One or more mode control buttons 109 may be configured as a toggle switch to toggle streaming music served wirelessly between two or more audio appliances. Ear piece 302 may be adapted to accept telephone voice streams from a wireless connected telephone during an audio stream from device 100. The volume for the streaming music may be automatically muted during a telephone voice transmission received from a connected telephone.

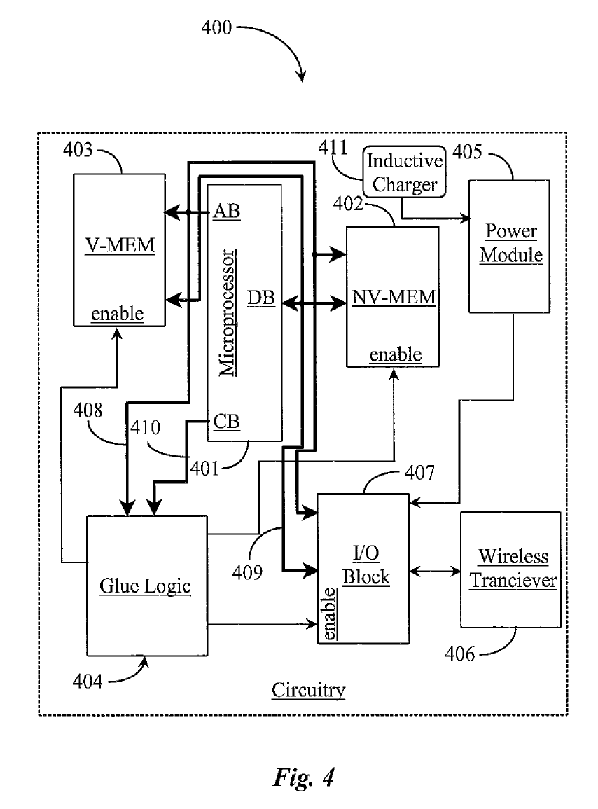

FIG. 4 is a block diagram illustrating basic electronic components of data storage device 100 of FIG. 1 in one embodiment. Most if not all of circuitry 400 is provided in an isolated fashion protected by hermetic sealing as described further above. A microprocessor 401 is provided and adapted as a central processing unit (CPU) of the computerized device. Microprocessor 401 has access to a volatile memory (V-MEM) 403. V-MEM 403 may be a random access memory (RAM) such as dynamic RAM (DRAM), static RAM (SRAM), or a combination (SDRAM).

Microprocessor 401 has access to a non-volatile memory (NV-MEM) 402. NV-MEM 402 may be a Flash-based memory such as NAND Flash. Typical local bus lines are provided and logically illustrated herein as bus structure including a data bus (DB) 409, an address bus (AB) 408, and a control bus (CB) 410. Glue logic 404 is provided within circuitry 400 and is adapted to provide the data conversion and device interface logic and circuitry for enabling basic integration between the device and other devices and systems. Glue logic 404 may include one or more transistor-transistor logic (TTL) devices or standard series 4000 integrated circuits (ICs). In a more complex implementation, glue logic 404 may include complex programmable logic devices (CPLDs) or one or more field programmable gate arrays (FPGAs), or combinations of chips in higher end devices.

Glue logic 404 enables custom programming of device routines relative to memory configuration and function of NV-MEM 401 and V-MEM 403. Glue logic 404 is controlled or enabled through control line 410 from microprocessor 401. In one embodiment memories 402, 403, microprocessor 401, and glue logic 404 may be integrated components of a custom microcontroller.

An input/output (I/O) controller block 407 is provided between the guts and memories of device (100) and a wireless transceiver 406. Wireless transceiver 406 accepts wireless data input from other devices and systems and transmits wireless data output to other devices and systems adapted for wireless communication. A power management module 405 is provided for supplying power to device (100) via a chargeable power cell or rechargeable battery.

Inductive charging may be applied to charge a power cell or one or more batteries on device (100). A magnetic induction coil and associated circuitry is logically illustrated in the example as an inductive charger 411 connected to power module 405. A power on/off switch such as a magnetic reed switch is not specifically illustrated in this example but may be assumed present and operational on device (100). An induction coil would be wired to power module 405 and a reed switch would be wired in path between the power module and the microprocessor (401).

In a simple form, the circuitry (400) of device (100) may support wireless USB protocols and task function for service as a wireless USB drive. In more complex embodiments device 100 is a multimodal device capable of multichannel communications with a variety of appliances and utilities adapted for wireless interface.

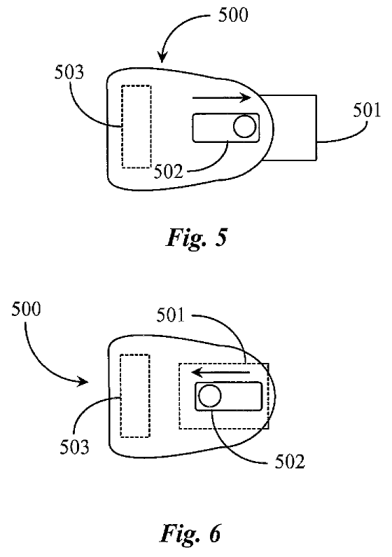

FIG. 5 is a top view of a removable dual-mode adapter head for data storage device 100 of FIG. 1 according to an embodiment of the present invention. FIG. 6 is a top view of the adapter head of FIG. 5 with the USB connector shown retracted.

Referring now to FIG. 5, adapter head 500 may be provided with wireless transceiver circuitry 503 and a retractable USB connector 501 operable by a slider control 502. Adapter head 500 may be adapted to snap onto the hermetically sealed body portion 102 of device 100 of FIG. 1. Contact points may be provided through the hermetic seal to enable coupling with USB connector 501 and with wireless transceiver 503. In this embodiment the device may be used as a standard USB drive ported to a computing appliance using physical USB connector 501. The device may also be used as a wireless USB drive or as a wireless node as described in various embodiments above. Referring now to FIG. 6, a user may retract USB connector 501 by manipulating slider control 502.

It will be apparent to one with skill in the art that the multimodal data storage device and system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A computerized appliance comprising:
a central processing unit (CPU);
a non-volatile data repository;
a wireless transceiver; and
a first code set resident and executable by the CPU in response to commands and data received at the appliance via the wireless transceiver;
wherein a first function of the first code set is to configure the appliance to execute, in response to an input signal via the wireless transceiver, a second code set resident and executable by the CPU, the second code set managing interaction with one or more external wireless devices via the wireless transceiver.

2. The appliance of claim 1 wherein a second function of the first code set is to receive and store a plurality of second code sets for later execution.

3. The appliance of claim 1 wherein a third function of the first code set is to recognize specific wireless signals and to establish network communication with other computerized appliances in response.

4. The appliance of claim 1 physically configured as a pocket-portable device.

5. The appliance of claim 1 hermetically sealed, and further comprising a power supply coupled to an inductive charger mechanism.

6. The appliance of claim 1 further comprising one or more input button switches for providing signals to the appliance.

7. The appliance of claim 6 wherein the appliance is hermetically sealed, and the button switches are membrane switches, providing input through the seal without breaking the seal.

8. The appliance of claim 1 wherein the appliance connects wirelessly to one or more computerized host appliances and is recognized by the one or more host appliances as a removable drive, and may function as a shared resource on a network or as a remote controller to a third-party utility.

9. The appliance of claim 8 wherein the wireless transceiver operates with one or more protocols, including Bluetooth™, Wi-Fi, or Ultra Wide Band (UWB).

10. The appliance of claim 1 further including a graphic display.

11. The appliance of claim 1 further comprising a USB connector for engaging a mating connector of another computerized appliance.
